(19) United States
(12) Patent Application Publication
(10) Pub. No.: US 2023/0104182 A1
(43) Pub. Date: Apr. 6, 2023

(54) Smart Wearable Sensor-Based Bi-Directional Assistive Device

(71) Applicants: Daniel Torres Hinojosa, Houston, TX (US); Quoc-Khanh Pham, Houston, TX (US); Mithil Chokshi, Houston, TX (US)

(72) Inventors: Daniel Torres Hinojosa, Houston, TX (US); Quoc-Khanh Pham, Houston, TX (US); Mithil Chokshi, Houston, TX (US)

(21) Appl. No.: 17/495,356

(22) Filed: Oct. 6, 2021

(51) Int. Cl. G09B 21/00; G06F 3/01; G06F 3/16; G01S 17/89; G06F 1/16

(52) U.S. Cl. CPC G09B 21/009; G06F 3/017; G06F 3/16; G01S 17/89; G06F 1/163

(57) ABSTRACT

Wearable systems and methods to allow for a two-way communication to convey ASL signing to a deaf person and translate the ASL to sound for communication to people with normal hearing. The system will also display signs to a deaf-mute person to communicate by having signs displayed visually from the corresponding sound or text input. The input can be captured on the device or streamed to the device using short range radio and the on-board computer will translate the different lingual inputs to a final output via a wireless device speaker or display. The LIDAR sensor on the device is able to sense the depth of the signs and should work in the low-light settings.

### CROSS REFERENCE TO RELATED APPLICATIONS

None.

### BACKGROUND

The embodiments herein relate generally to sensor systems, and more particularly to, a smart, wearable, sensor-based bi-directional assistive device.

Communication for disabled people with the non-disabled people, is slow and not of high fidelity on daily basis and on routine tasks. Communication with people who don't have knowledge of sign language is often difficult or impossible. Sensory perception of the immediate surroundings, environmental (for example, different light settings), hazardous circumstances and emergency situations is greatly reduced by their disabilities, which is potentially also an issue for non-disabled individuals.

Competitors either provide second person view, from terminal or facing disabled person, or first person without integrating & merging facial/frontal signs. Competing devices only enable a uni-directional communication (meant for post-processed communication rather than a real-time conversation).

The current state of art regarding real-time ASL translating devices is centered around non-wearable devices and the use of graphic representations or cartoons. The technology is mainly focused on devices lacking the capability of being portable, unidirectional communication and on cameras/detectors positioned in front of the users.

Some previous work done provides a cartoon ASL representation after having a sound input from either a person or a device, failing to establish the other direction of communication.

Another approach uses a fixed in location device which is not practical for use on a regular daily conversation with other individuals. This type of technology doesn't achieve the main goal of providing the user the ability of communicating freely and anchors them to a specific location of the device or burdens them with carrying a large size apparatus.

### SUMMARY

In one aspect of the subject technology, a wearable, bi-directional, device for assisting communication with one or more speech impaired persons is disclosed. The device includes a housing, at least one visual sensor positioned on the housing, and a processor coupled to the visual sensor. The processor is configured to: detect a gesture from either a wearer of the device or from another person communicating with the wearer of the device, the processor may also, determine a sign language meaning associated with the gesture. The processor provides the sign language meaning to the wearer. The device also includes an output element for displaying or audially emitting the provided sign language meaning to the wearer.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of a bi-directional sensor-based assistive communication system according to an embodiment of the subject technology.

FIG. 2 is a front elevational view of a bi-directional sensor-based assistive device according to embodiments.

FIG. 3 is a right side elevational view of the device of FIG. 2 according to an embodiment of the subject technology.

FIG. 4 is a left side elevational view of the device of FIG. 2 according to an embodiment of the subject technology.

FIG. 5 is a top plan of the device of FIG. 2 according to an embodiment of the subject technology.

FIG. 6 is a bottom plan of the device of FIG. 2 according to an embodiment of the subject technology.

FIG. 7 is a rear view of the device of FIG. 2 according to an embodiment of the subject technology.

FIG. 8 is a block diagram of a bi-directional sensor-based assistive device according to an embodiment of the subject technology.

FIG. 9 is a block diagram of a communication system according to another embodiment of the subject technology.

FIG. 10 is a diagrammatic view of an example image array processed by aspects of the subject technology.

FIG. 11 is a diagrammatic view of a sensor input array data processed by aspects of the subject technology.

### DETAILED DESCRIPTION OF CERTAIN EMBODIMENTS

In general, and referring to the Figures, embodiments of the subject technology provide a smart wearable sensor-based bidirectional assistive system 10 (sometimes referred to generally as the “system 10”) that facilitates the interaction between a disabled person or non-disabled person, other individuals, and the environment. The system 10 is generally wearable. Aspects of the system 10 recognize various gestures, including for example, facial and frontal signs. The system 10 may also process and hold conversations with multiple speakers and localize the target of conversation through a microphone array. Aspects of the processing in the system 10 provides contextual intelligence, with ability to predict words in order to reduce translation delays while offering minimal error rate. In some embodiments, the system 10 may connect wirelessly to smartphones, smart watches, and remote displays (IoT) in order to provide sign language representations. The subject technology may also provide assistance in a variety of situations aside from translation (for example, modeling an environment in 3D and measuring distances/dimensions using LiDAR).

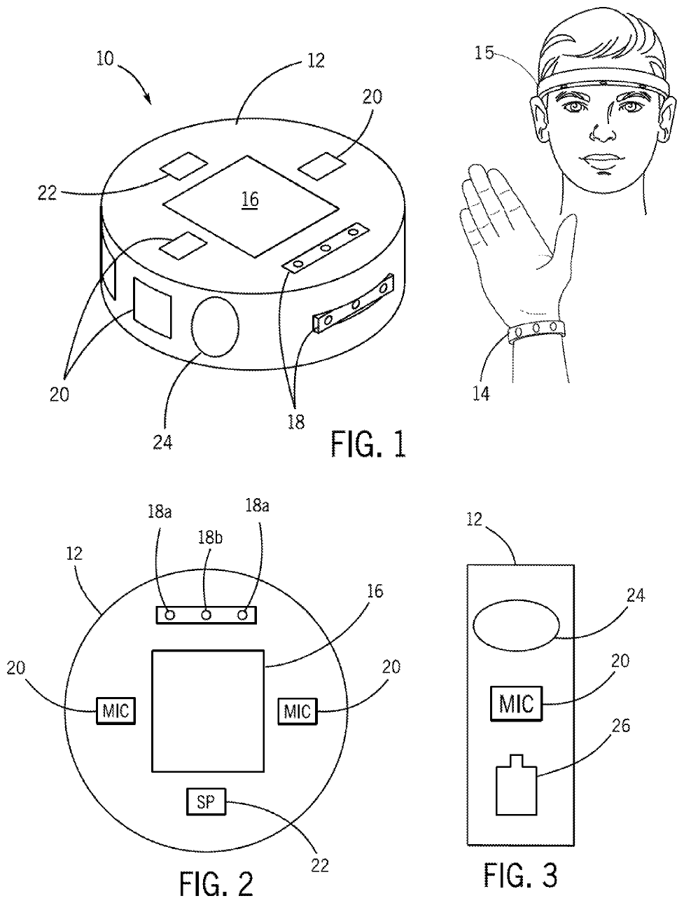

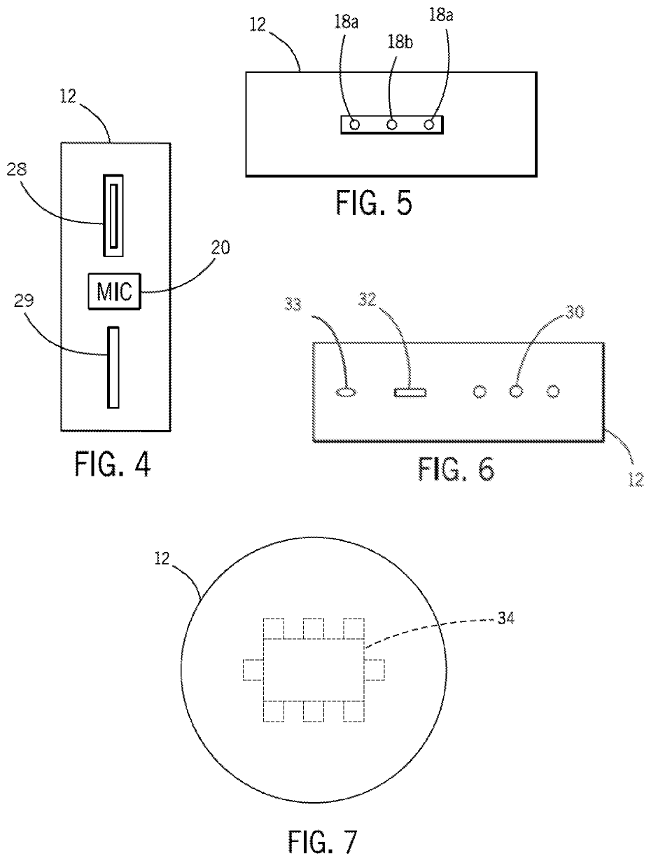

Referring now to FIGS. 1-8, specific features of the system 10 will be described in more detail according to exemplary embodiments. In one embodiment, the system 10 generally includes a primary wearable sensor device 12 (sometimes referred to generally as the “device 12”). The device 12 is shown as a puck or disc, however it will be understood that the shape of the device 12 may be modified while remaining within the scope of the subject technology. The device 12 may be worn for example, on a person's torso or other location on the body that may be forward facing, so that the device 12 is in position to recognize hand (or other appendage) or face gestures, recognize lip movement, pick up sound or other detectable energy signal. Referring temporarily to FIG. 7, embodiments may include a fastening element 34 that attaches the device housing to a user's clothing. Some embodiments may include one or more secondary wearable sensor devices. As shown, the system 10 includes a secondary device 14 and/or secondary device 15. The secondary device 14 and/or the secondary device 15 may include the same detection, processing, and transmitting components as the primary device 12. The secondary wearable devices 14/15 may be worn by the same user as the primary device 12. The secondary wearable devices 14/15 may be worn in a different location than the primary device 12 to provide augmented recognition of signals and communication for the wearer. The secondary device 14 is shown as a bracelet. The secondary device 15 is shown as a headband. However, it will be understood that secondary devices may take other forms while performing the same function.

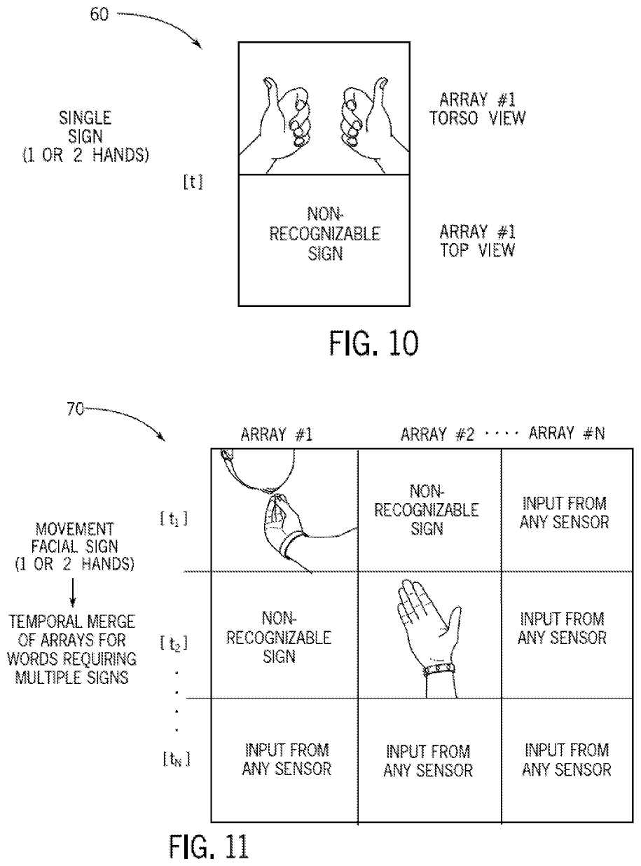

In an exemplary use, the primary device 12 may be worn on the torso, (for example. chest, abdomen, waist). Accordingly, the “field of view” (FoV) (the area of detection) for the device 12 is generally within the area directly in front of the body part where the device is worn. The torse is an actively moved area so the FoV for the device 12 may sometimes be out of alignment with whom (or what) the subject wearer is communicating. For example, another person may be to the user wearer's side. The secondary devices 14 or 15 may be worn on other body locations that cover the direction the user needs when the primary device 12 is not adequately picking up an input. In some embodiments, and as seen in more detail in FIGS. 10 and 11 below, each worn device may receive an input which is processed by the system 10 and all inputs may be used to determine the meaning of the communication input being received.

Aspects of the device 12 enables the user to interact with another human and with the environment and also takes real-time inputs from the human or the environment for a seamless conversation. The device 12 may include an array of sensors that allows it to work in low light settings and in complete darkness. The device 12 has a contextual intelligence that learns and adapts to the user's physical and environmental parameters. The device 12 may also be used by non-disabled users to augment their interaction with the environment for safety, health, conversation, training, IoT connectivity, and many other reasons.

In an exemplary embodiment, the device 12 is configured with hardware optimized for recognizing voice and sign language. The device 12 detects signs using both first-person and second-person views. In an exemplary embodiment, the device 12 includes a plurality of sensors 18 positioned on multiple surfaces of the housing. The multiple surfaces of the housing face in different directions so that the sensors 18 may detect signals from different perspectives. The sensors 18 may be positioned on a front face and side wall of the device 12 housing. The sensors 18 on the front face may be disposed to detect forward facing signals. The sensors 18 on the sidewall may be disposed to detect signals from top and bottom facing views to recognize facial signs and expressions. The sensors 18 on the side wall provide a first-person view of the user's hands (torso to hands view angle). As may be appreciated, this perspective may be a major difference compared to most current sign language detection systems that usually analyze hand signs from only the front view perspective. In an exemplary embodiment, the sensors 18 may be visual type sensors that include a stereoscopic cameras 18a and LIDAR detectors 18b. Embodiments may include of far-field/beamforming microphones 20 on multiple surfaces of the device housing. The microphones 20 are disposed to pick up audio from others, the environment surrounding the user, and from the user. Some embodiments may include a speaker 22 that transmits synthesized communication (for example, translated signals to speech) from the device 12. In some embodiments, the device 12 may include a digital display 16. In an exemplary embodiment, the processing modules (described further below) may process input so that the device 12 displays digitally replicated hand signs to, for example, a deaf-mute person to communicate by having signs displayed visually from the corresponding sound or text input captured by the sensors. The LIDAR sensor 18b on the device 12 is able to sense the depth of the signs from another person and works in the low- to minimal-light settings. The input can be captured on the device 12 or streamed to the device using short range telecommunications. An on-board computer (discussed in more detail below) will translate the different inputs (lingual, visual, environmental sound) to a final output via speaker or a wireless device such as a smartphone, smartwatch or remote terminal.

Some embodiments may include auxiliary components for operation of the device 12. For example, embodiments may include a fingerprint sensor 24 as a security feature providing access to the device 12 by the user. The fingerprint sensor 24 may be used to limit access to the user and/or to turn the device 12 on from a powered down state. Some embodiments may include a battery level indicator 26 so that the user may know when to recharge the device 12. Recharging and/or wired data transmission may be performed through a universal serial bus (USB) port 28. Some embodiments may include a memory card slot 29 for receiving auxiliary memory storage or auxiliary software program loaded into the device permanent storage. Some embodiments may be configured for wireless telecommunication through a cellular network and may include a SIM card module 32. A control keypad 30 may include buttons for controlling features such as power on/off, volume, display control, sensor sensitivity, and programmable functions. Embodiments present easy-access buttons on its housing that can be used to turn the device on or off, restarting it, cycling through different feature modes, activating contactless payment, capturing images via camera, etc.

As a portable wearable device, some embodiments may use a Lithium or Li—Po battery of appropriate voltage and amps to be able to power the device 12 for at least one full day. In the scenario where a lithium battery is used, device operations may be limited to less than 100 watts per hour in order to comply with TSA requirements. As part of the power-saving strategy, the device 12 may be configured to turn off some of its sensors when no sign is being detected (for example, until one of the IR LiDAR lasers detect movement and wake the rest of the detection system) and adjust its processing units to lower frequencies. The device 12 may use low-powered proximity technology that can detect the presence of “short-distance twin objects” in order to automatically wake up the system (hands are usually located the same distance from one another and both hands are at a specific distance from torso, thus considered “twin objects”. In some embodiments, the device 12 may be charged using a coil induction system such as Qi standard or magnetic charging, via cable connection such as USB standards through the port 28. The cable port 28 may also be used in service mode to provide serial SSH UART access LED indicators may show charging status while the device 12 is docked.

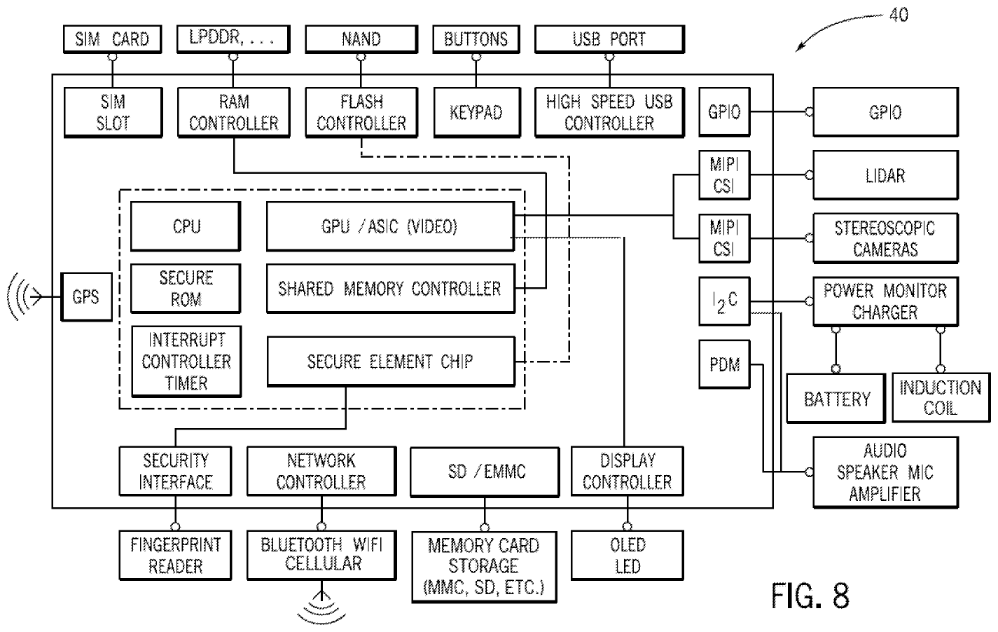

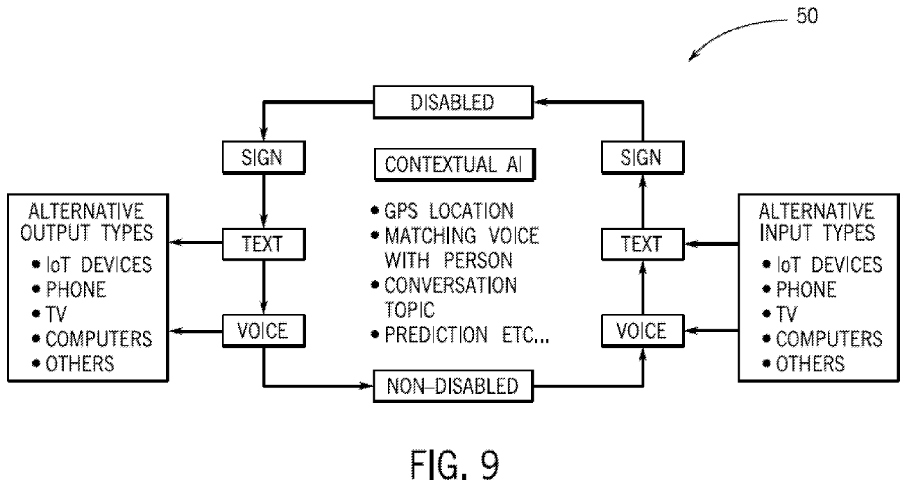

Referring now to FIGS. 8 and 9, aspects of the operation and control of system 10 devices are discussed according to embodiments. FIG. 8 shows a control architecture 40 according to an exemplary embodiment. In some embodiments, the system 10 stores private data within a secure enclave chip. Data includes personal vocal cue elements, words/signs database as well as contextual information such as frequent locations/speakers interaction. A-main controller module may include a CPU, a graphics chip (GPU/ASIC), a shared memory controller, a secure element chip, a secure ROM module, and an interrupt controller timer.

In general embodiments, the device 12 includes a PCB board that includes all the necessary components (ASIC, CPU, GPU, RAM, flash storage, EEPROM, BIOS chip, DART.) needed to provide enough processing to handle high-throughput video camera and LiDAR depth data streams. The device uses low-power ARM or ASIC processor chips. The sensors are connected via GPIO interface or alternative suitable connections.

The device 12 is firmware and software-upgradeable in order to provide long-term support (bug fixes, new features, improved algorithms etc.). The device 12 may be compatible for connection to a user computer to synchronize collected data. Collected data can include health data taken throughout the day or sign recognition data that can be used to improve sign language model via a machine learning/neural network. Collected data may be identified and stored on the secure element chip. The secure element chip enclave may be configured for tamper-resistant contactless payment, authentication, digital signature, storage of cryptocurrency private keys, confidential documents. Onboard storage memory may be expanded via external memory cards (proprietary or SD/CF/Misc. standard received by the card slot 29. Expanded functionality is made via the addition of external sensor modules connected to the expansion port 33.

In an exemplary operation, the first layer of sign recognition matches words to each individual sign by capturing video images from stereoscopic camera arrays (pseudo-LiDAR) and depth data from LiDAR sensors 18b (true LiDAR). LiDAR sensors 18b are not meant to replace the stereoscopic camera arrays, but are included as a technology that can improve accuracy of the detection recognition, while providing the ability to recognize signs in complete darkness. Sign representations may be displayed on a wirelessly connected smartphone/smart wearable/computer with tailored assistive UI. For each sensor type, there is an associated model, but data from both models can be merged to increase accuracy of the sign recognition. Models are constructed by capturing as many hand sign images as possible, labelling hand signs with boxes, generating matching script including position/dimension of these boxes for each image, and then using, machine learning/neural networks such as TensorFlow running at predefined amount of steps (the more the better for accuracy). An example input/output schema 50 is shown in FIG. 9. In FIG. 10, an example array of inputs captured by different array perspective is shown. As can be seen, one input may be readily visible by the perspective while the other array is unable to capture a usable image because the object is out of view. FIG. 11 shows an example array merging input from different detection points that the onboard processing system may use to translate whether there is communication occurring and the meaning being conveyed, if any. As can be seen by the representation of the array, while the physical embodiments above showed approximately ten sensors of different types, embodiments may include more sensors which are represented by the array 70.

The second layer of sign recognition uses proprietary artificial intelligence (AI) that can quickly analyze words and sentences, make sense of the context and generate a smooth, gapless, natural, and expressive speech that can be read at selected volume through the embedded speaker 22. The device 12 may generate/map a voice that can match the user's facial features (the opposite of MIT CSAIL—Speech2Face via supervised learning). As opposed to voice assistant Al, disabled users are actual humans. Therefore, their voice is tightly tied to their appearance and unique personality. Besides the pure translational aspect, the device 12 is able to convey emotions by not only matching the physical aspect of the user with the voice, but the processing module(s) also intelligently vary the tone and volume of the voice depending on the context. In some embodiments, the above described process may be done completely offline for advantages related to faster speed, no need to rely on wireless external connectivity to reach remote database servers, lower battery consumption and so on.

In some embodiments, the system 10 may go through a calibration process when the device 12 is first being used in order to determine the rate at which the user makes hand signs. By determining the sign rate, it can allow the system 10 to create segments to recognize signs more easily. Data streams from top and front sensor arrays may be combined in a temporal fashion in order to map signs that combine two-hand sign actions. FIG. 11 shows a two-hand sign detected from different sensor perspectives.

Speech coming from non-disabled surrounding people may be picked up by the microphone(s) 20. The detected speech may be converted into text (STT—Speech-To-Text). The conversion process may be performed offline using machine learning trained models stored on the device itself. In some embodiments, the text may be converted into visual 2D or 3D hand sign representations. Representations can either be just animated or static hands or animated or static avatar characters selected by the user. Users can customize the appearance of representations. Representations can be visualized on remote displays or displays embedded into other devices such as smartphones, wearable devices, computers or smart glasses.

Additionally, in some embodiments, the device 12 may include haptic feedback features that alert the user when speech is being detected. This is helpful in a situation where the disabled person is not looking/facing non-disabled person, so there is no way, for them to, react immediately or even be aware that speech is occurring.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module, ” or “system.” Furthermore, aspects of the, disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A wearable, bi-directional, device for assisting communication with one or more speech impaired persons, comprising:
a housing;
at least one visual sensor positioned on the housing; and
a processor coupled to the visual sensor, wherein the processor is configured to:
detect a gesture from either a wearer of the device or from another person communicating with the wearer of the device,
determine a sign language meaning associated with the gesture, and
provide the sign language meaning to the wearer;
at least one output element for displaying or audially emitting the provided sign language meaning to the wearer.

2. The device of claim 1, further comprising one or more microphones coupled to the processor, wherein the processor is configured to translate audio signals picked up by the one or more microphones and translate the audio signals into text or a hand sign symbol.

3. The device of claim 1, wherein the at least one visual sensor uses light detection and ranging (LIDAR).

4. The device of claim 3, wherein the processor is configured to determine a depth of imagery from signals detected by the LIDAR.

5. The device of claim 1, wherein the at least one visual sensor is a stereoscopic camera.

6. The device of claim 1, wherein the at least one visual sensor includes a plurality of visual sensors positioned on multiple surfaces of the housing and wherein the multiple surfaces of the housing face in different directions.

7. The device of claim 6, wherein a first visual sensor is positioned on a forward facing surface of the housing and a second visual sensor is positioned on an upward or downward facing surface of the housing.

8. The device of claim 6, wherein the processor is further configured to:
determine a visual sensor source of inputs,
merge input signals from different visual sensors facing different directions, and
determine a hand sign being detected based on the merged input signals.

9. The device of claim 1, wherein the output element is a digital display, and the processor is configured to generate digitally replicated hand signs on the digital display.

10. The device of claim 1, wherein the output element is a speaker, and the processor is configured to generate synthesized speech.
